(19) United States
(12) Patent Application Publication
(10) Pub. No.: US 2010/0125660 A1
(43) Pub. Date: May 20, 2010

(54) RECORDING APPARATUS, METHOD, AND COMPUTER READABLE STORAGE MEDIUM STORING PROGRAM THEREOF

(75) Inventor: Masahiko MURAKAMI, Kawaski (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/273,693

(22) Filed: Nov. 19, 2008

(30) Foreign Application Priority Data
Nov. 19, 2008 (JP) 2007-299063

(51) Int. Cl. G06F 15/16

(52) U.S. Cl. 709/224

(57) ABSTRACT

When the communicator sends a communication message for Web access, the monitor suspends the sending process of the communication message in the communicator. The start determiner instructs the operation recorder to start the recording process of data indicative of user operations. The monitor allows the communicator to resume the sending process of the communication message. The operation recorder sets a capture interval to the timer. When the user performs input operations, the operation recorder records the input data. If the remaining time of the timer is 0, the operation recorder captures and records the screen data, and sets the capture interval to the timer. If the end determiner has instructed to end the recording process, the operation recorder closes the file for storing the operation data and stores the file in the operation storage.

### BACKGROUND OF THE INVENTION

1. Field of the Invention

The present invention relates to an apparatus for recording data indicative of user operations, and more particularly, to a recording method for automatically recording data on operations in use of online services which seem to be important for the user.

2. Description of the Related Art

The online services such as online shopping and online banking have become widely used with the wide spread of PCs (personal computers) and the Internet. Meanwhile, a system trouble or user's operational mistake causes an incorrect order or incorrect remittance, and a trouble occurs between a service provider (bank or shopping mall) and a user. In order to solve the trouble early, recording, as a proof, of user's action on service use is demanded.

For this purpose, a technology for recording a history of user access to a service server is proposed (e.g., Japanese Laid-open Patent Publication No. 2006-146371).

### SUMMARY

Even if the history of user access to the service server is available, it does not show the specific operations of the user. Continuous recording of data indicative of user operations is not practical because it needs enormous resources. Recording when the user determines to be important is bothersome for the user and the recording is easily forgotten. Accordingly, it is an object of the present invention to provide a recording apparatus that automatically records data indicative of user operations that seem to be important for the user.

According to one aspect of the present invention, provided is a recording apparatus for recording data indicative of user operations. The recording apparatus includes a monitor which monitors a sending process or receiving process of a communication message to acquire the message, a start determiner which determines, by analyzing acquired communication message, whether to start a recording process of data indicative of user operations executed after sending or receiving the acquired communication message, and an operation recorder which starts the recording process in accordance with a determination result in the start determiner.

The start determiner of the recording apparatus may include at least one of a first determiner, a second determiner, and a third determiner. The first determiner determines to start the recording process when the acquired communication message complies with a cipher communication protocol, and outputs a determination result indicating an instruction of starting the recording process. The second determiner determines to start the recording process when a source of an acquired receiving communication message or a destination of an acquired sending communication message is a predetermined server, and outputs a determination result indicating an instruction of starting the recording process. The third determiner determines to start the recording process on the basis of a content of the acquired communication message, and outputs a determination result indicating an instruction of starting the recording process.

The operation recorder of the recording apparatus may include at least one of a first recorder and a second recorder. The first recorder records, as the data indicative of user operations, screen data for a screen image displayed during the user operations. The second recorder records, as the data indicative of user operations, data input during the user operations.

The operation recorder of the recording apparatus may send, as the recording process, the data indicative of user operations to an apparatus connected through a communication network.

The start determiner of the recording apparatus may identify, on the basis of the acquired communication message, a session management process of a sending process or receiving process of the acquired communication message and determines whether to start the recording process for each of identified session management processes, and the operation recorder may record data indicative of user operations accepted by a window management process corresponding to each of the identified session management processes.

The recording apparatus may further include a notice issuer which issues, during the recording process, a notice to the effect that a recording process is going.

The recording apparatus may further include a prior notice issuer which issues, upon outputting a determination result indicating an instruction of starting the recording process, a prior notice to the effect that a recording process is about to start. The operation recorder starts the recording process of data indicative of user operations after the prior notice has been issued.

The operation recorder of the recording apparatus may record, along with the data indicative of user operations, data of a source of an acquired receiving communication message or a destination of an acquired sending communication message.

The recording apparatus may further include at least one of a first end determiner, a second end determiner, a third end determiner, and a fourth end determiner. The first end determiner determines to end the recording process after a predetermined time from a start of the recording process, and instructs end of the recording process. The second end determiner determines to end the recording process upon detecting an access to a server different from a server as a source of an acquired receiving communication message or a destination of an acquired sending communication message, and instructs end of the recording process. The third end determiner determines to end the recording process upon detecting a closing of a window managed by a window management process corresponding to a session management process of a sending process or receiving process of the acquired communication message on the basis thereof the recording process has been determined to start, and instructs end of the recording process. The fourth end determiner determines to end the recording process after a predetermined time of absence of user operations after a start of the recording process, and instructs end of the recording process.

### BRIEF DESCRIPTION OF THE DRAWINGS

FIG. 1 is a diagram illustrating a system configuration of a recording apparatus according to a first embodiment of the present invention;

FIG. 2 is a diagram illustrating an example of a URL list stored in a condition storage in a recording apparatus according to a first embodiment of the present invention;

FIG. 3 is a diagram illustrating a flowchart of a record start/end instruction process in a recording apparatus according to a first embodiment of the present invention;

FIG. 4 is a diagram illustrating a flowchart of a recording process of data indicative of user operations in a recording apparatus according to a first embodiment of the present invention;

FIG. 5 is a diagram illustrating an example of packet format of an Ethernet packet;

FIG. 6 is a diagram illustrating a system configuration of a recording apparatus according to a second embodiment of the present invention;

FIG. 7 is a diagram illustrating an example of a URL list stored in a condition storage in a recording apparatus according to a second embodiment of the present invention;

FIG. 8 is a diagram illustrating a flowchart of a recording process of data indicative of user operations in a recording apparatus according to a second embodiment of the present invention; and

FIG. 9 is a diagram illustrating an example of a computer environment.

### DESCRIPTION OF THE PREFERRED EMBODIMENTS

Hereinafter, discussions will be given on embodiments of the present invention with reference to the drawings.

### First Embodiment

A recording apparatus according to a first embodiment of the present invention is constructed on a personal computer (PC) that communicates with a service server through the Internet.

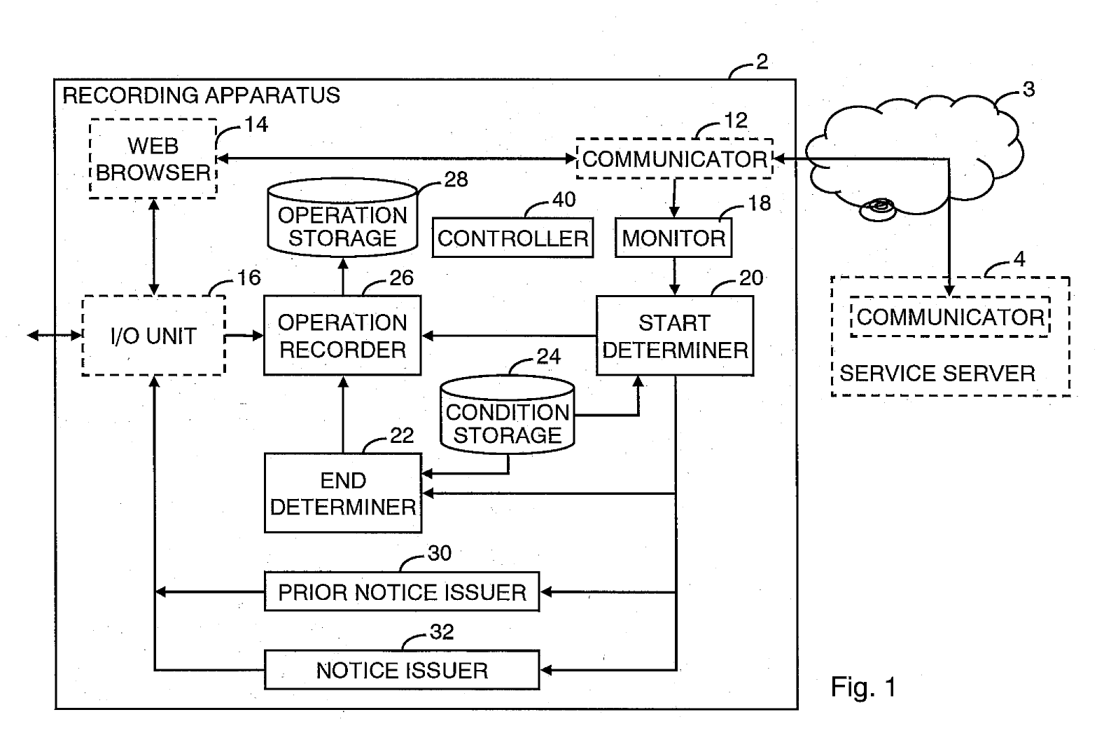

FIG. 1 is a diagram illustrating a system configuration of a recording apparatus according to a first embodiment of the present invention. A recording apparatus 2 according to the first embodiment of the present invention is connected to a service server 4 through a communication network 3 such as the Internet. The recording apparatus 2 includes: a communicator 12 that performs sending process and receiving process of a communication message; a Web browser 14 that analyzes the received communication message on the basis of a WWW (World Wide Web) protocol, generates output data, and transmits via the communicator 12 input data input from a user; an I/O (input/output) unit 16 that outputs the output data generated by the Web browser 14 and accepts the input data input from the user; a monitor 18 that monitors a sending process or receiving process of a communication message to acquire the message; a start determiner 20 that determines, by analyzing the communication message acquired by the monitor 18, whether to start the recording process; an end determiner 22 that determines to end the recording process and instructs to end the recording process; a condition storage 24 that stores conditions for determining a start and end of the recording process; an operation recorder 26 that performs the recording process of data indicative of user operations; an operation storage 28 that stores the data indicative of user operations; a prior notice issuer 30 that outputs via the I/O unit 16 a prior notice indicating that recording process is about to start; a notice issuer 32 that outputs via the I/O unit 16 a notice indicating that the recording process is going; and a controller 40 that entirely controls the recording apparatus 2.

Functions of the communicator 12, the Web browser 14, and the I/O unit 16 are similar to those provided for the existing PC. The controller 40 executes all functions, that are not explicitly discussed in the specification, of the recording apparatus 2, including functions of a normal PC.

Hereinafter, the first embodiment of the present invention will be discussed using case examples. In the first embodiment of the present invention, the recording process of data indicative of user operations starts upon sending or receiving a communication message satisfying a predetermined condition via the communicator 12. Further, the recording process ends upon satisfying another predetermined condition. In the following example, the recording process starts upon accessing a pre-registered specific URL (Uniform Resource Locator) and ends upon accessing another site.

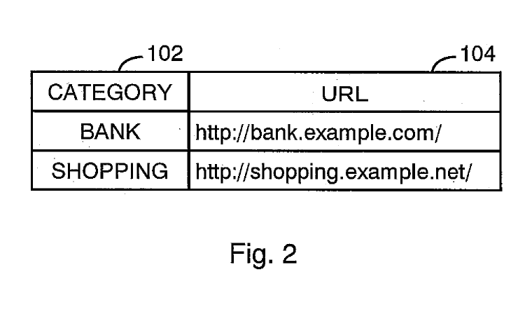

FIG. 2 is a diagram illustrating an example of a URL list stored in a condition storage in a recording apparatus according to a first embodiment of the present invention. The condition storage 24 stores a URL of an access destination, the recording process of data indicative of user operations starts upon access thereto. In the example shown in FIG. 2, a record of a URL list stored in the condition storage 24 includes a “category” section 102 and a “URL” section 104. The “category” section 102 stores data indicating a category of the access site and is not necessarily required. The “URL” section 104 stores a URL capable of identifying the access destination.

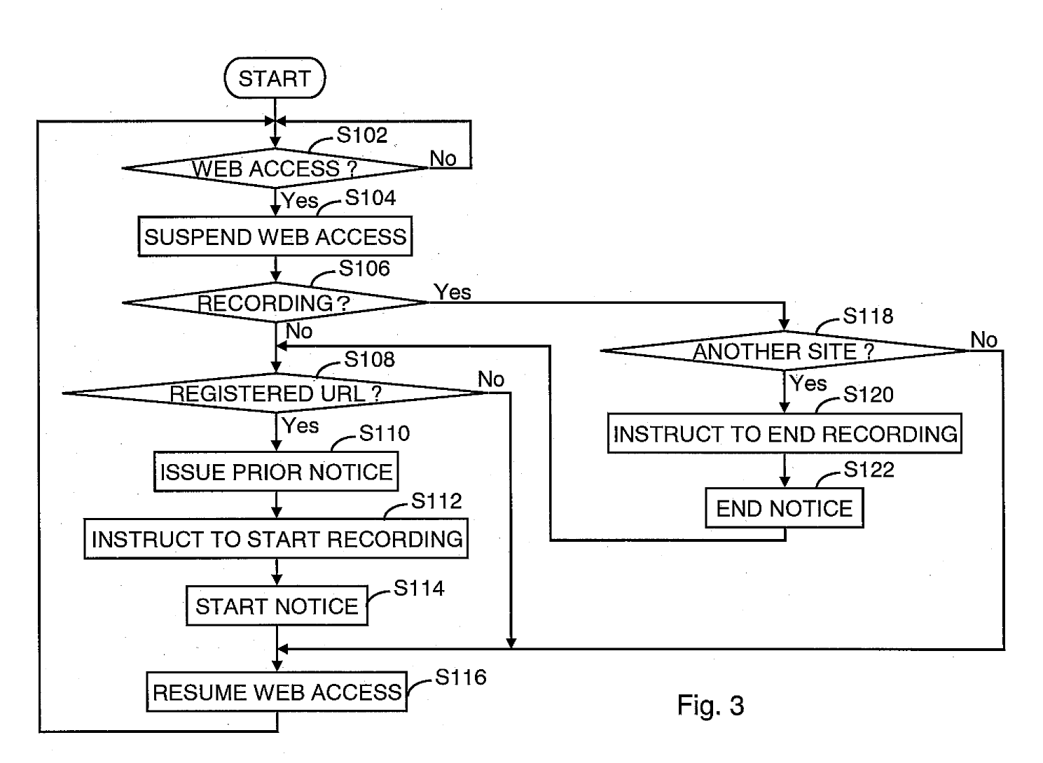

FIG. 3 is a diagram illustrating a flowchart of a record start/end instruction process in a recording apparatus according to a first embodiment of the present invention. A discussion will be given on a flow of record start/end instruction process according to the first embodiment of the present invention with reference to FIG. 3.

(Operation S102) The monitor 18 monitors whether the communicator 12 is about to send a communication message for accessing the Web.

(Operation S104) When the communicator 12 is about to send the communication message for accessing the Web (Yes in Operation S102), the monitor 18 suspends the sending process of the communication message in the communicator 12.

(Operation S106) The start determiner 20 checks whether the operation recorder 26 is recording data indicative of user operations.

(Operation S108) If the operation recorder 26 is not recording data indicative of user operations (No in Operation S106), the start determiner 20 checks whether the URL of the access destination is stored in the condition storage 24. If the URL of the access destination is not stored in the condition storage 24 (No in Operation S108), the process advances to Operation S116.

(Operation S110) If the URL of the access destination is stored in the condition storage 24 (Yes in Operation S108), the prior notice issuer 30 outputs via the I/O unit 16 a prior notice to the effect that the recording process of data indicative of user operations is about to start.

(Operation S112) The start determiner 20 instructs the operation recorder 26 to start the recording process of data indicative of user operations.

(Operation S114) The notice issuer 32 starts an output, via the I/O unit 16, of a notice to the effect that the recording process of data indicative of user operations is going.

(Operation S116) The monitor 18 resumes the sending process of the communication message in the communicator 12. Thereafter, the process advances to Operation S102.

(Operation S118) If the operation recorder 26 is recording data indicative of user operations (Yes in Operation S106), the end determiner 22 checks whether the URL of the access destination is one in another site. If the URL of the access destination is not one in another site (No in Operation S118), the process advances to Operation S116.

(Operation S120) If the URL of the access destination is one in another site (Yes in Operation S118), the end determiner 22 instructs the operation recorder 26 to end the recording process of data indicative of user operations.

(Operation S122) The notice issuer 32 ends the output of the notice to the effect that the recording process of data indicative of user operations is going. Thereafter, the process advances to Operation S108.

According to the first embodiment of the present invention, captured data of a display image within a display window of the Web browser and input data from an input device such as a mouse or keyboard are recorded as the data indicative of user operations.

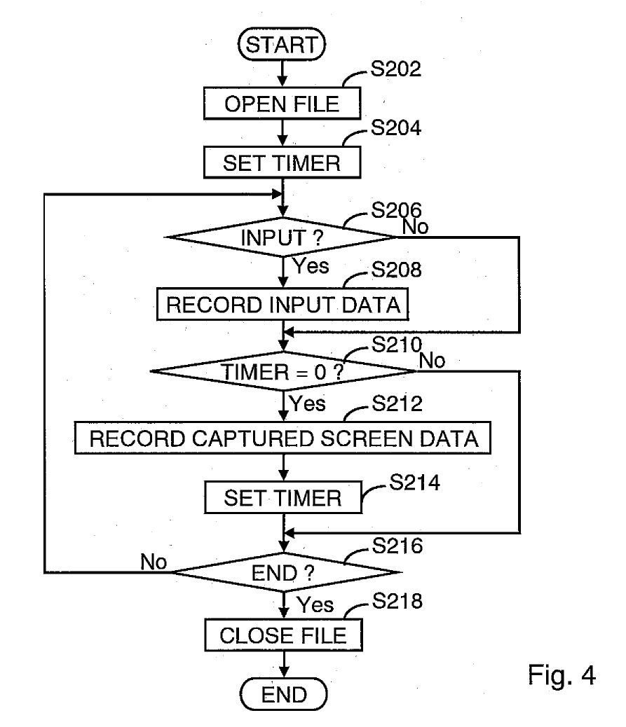

FIG. 4 is a diagram illustrating a flowchart of a recording process of data indicative of user operations in a recording apparatus according to a first embodiment of the present invention. A flow of the recording process of data indicative of user operations according to the first embodiment of the present invention will be discussed with reference to FIG. 4.

(Operation S202) The operation recorder 26 creates and opens a file for storing operation data and writes the URL of the access destination to the file for storing the operation data. Further, the operation recorder 26 identifies a session management process of the sending process of the communication message. Herein, the session management process manages only a single session.

(Operation S204) The operation recorder 26 sets a capture interval (e.g., 100 ms) to a timer for screen capture.

(Operation S206) The operation recorder 26 checks whether the user performs input operations for window management process corresponding to the session management process identified in Operation S202. If the user does not perform input operations (No in Operation S206), the process advances to Operation S210. Herein, a window management process corresponds to only a single session management process. That is, a plurality of sessions are not kept in parallel therewith in an operation window managed by one window management process. When a plurality of screens with tabs are displayed in one operation window and sessions varying depending on the screens with the tabs are kept, each process managing each of the screens with the tabs is assumed as the window management process.

(Operation S208) If the user performs input operations (Yes in Operation S206), the operation recorder 26 records input data.

(Operation S210) The operation recorder 26 checks whether the remaining time of the timer for screen capture is 0. If the remaining time of the timer for screen capture is not 0 (No in Operation S210), the process advances to Operation S216.

(Operation S212) If the remaining time of the timer for screen capture is 0 (Yes in Operation S210), the operation recorder 26 captures and records screen data.

(Operation S214) The operation recorder 26 sets the capture interval to the timer for screen capture.

(Operation S216) The operation recorder 26 checks whether the end determiner 22 has instructed to end the recording process. If the end determiner 22 has not instructed to end the recording process (No in Operation S216), the process advances Operation S206.

(Operation S218) If the end determiner 22 has instructed to end the recording process (Yes in Operation S216), the operation recorder 26 closes the file for storing the operation data, and stores the closed file in the operation storage 28.

According to the first embodiment of the present invention, recording process of data indicative of user operations starts when the user starts to access a specific URL registered in advance. The recording process continues while the user accesses the site. When the user starts to access another site, the recording process of data indicative of user operations ends. However, if the URL of the access destination upon accessing another site is another specific one registered in advance, the recording process of data indicative of user operations starts again.

According to the first embodiment of the present invention, the start timing of the recording process of data indicative of user operations is set to when a specific URL registered in advance is accessed. The present invention is not limited to this and an arbitrary condition may be set. For example, the start timing of the recording process may be set to when a communication message from a specific source registered in advance is received. Alternatively, the start timing of the recording process may be set to when a communication message complying with an encryption communication protocol is sent or received. Further, alternatively, the recording process may start on the basis of contents of the communication message to be sent or received. Furthermore, the recording process may start upon satisfying any of a plurality of arbitrary conditions including the above conditions. Hereinafter, a discussion will be given on an example of the recording process started when the communication message complying with an encryption communication protocol is sent.

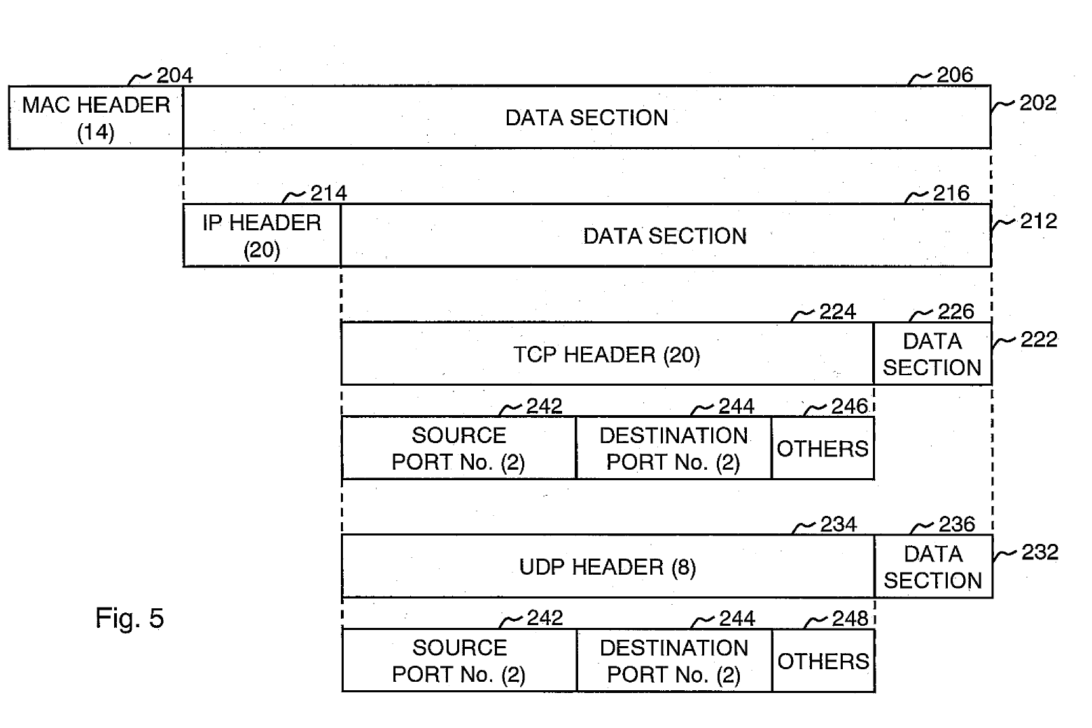

FIG. 5 is a diagram illustrating an example of packet format of an Ethernet (registered trademark) packet. An Ethernet packet 202 includes a MAC header 204 and a data section 206. The data section 206 may be an IP packet 212. An IP packet 212 includes an IP header 214 and a data section 216. The data section 216 may be a TCP packet 222 or a UDP packet 232. A TCP packet 222 includes a TCP header 224 and a data section 226. A TCP header 224 includes a source port number 242, a destination port number 244, and others 246. A UDP packet 232 includes a UDP header 234 and data section 236. A UDP header 234 includes a source port number 242, a destination port number 244, and others 248. Assume that HTTPS (Hypertext Transfer Protocol Security) is used for the encryption communication protocol for accessing a WEB site. A well-known port corresponding to HTTPS has a port number “443”. Therefore, values of the source port number 242 and the destination port number 244 of an Ethernet packet including a request message or a response message are generally “443”. Then, in Operation S108 in FIG. 3, the start determiner 20 checks whether the value of the source port number 242 or the destination port number 244 of the communication message to be sent by the communicator 12 is “443”, in place of checking whether the URL of the access destination is stored in the condition storage 24. As a consequence, it is possible to start the recording process upon sending the communication message complying with the encryption communication protocol.

According to the first embodiment of the present invention, the end timing of the recording process of data indicative of user operations is set to when the user starts to access another site. However, the present invention is not limited to this and an arbitrary condition may be set. As an example, the recording process may end after the passage of a predetermined time from the start of the recording process. Alternatively, the recording process may end upon closing the display window that displays the screen image of the Web access. Further, alternatively, the recording process may end when the user does not perform the input operation for a predetermined time. Furthermore, alternatively, the recording process may end upon satisfying any of arbitrary conditions including the above ones.

According to the first embodiment of the present invention, it is possible to provide a recording apparatus that automatically records user operations that seem to be important for the user by detecting, in accordance with a predetermined condition, reception or transmission of a communication message that seems to be important for the user and keeping a record of subsequent user operations.

### Second Embodiment

A recording apparatus according to a second embodiment of the present invention is arranged out of a client PC for communicating data with the service server through the Internet. Further, it is assumed that the user operates the client PC from a thin client through a communication network. Input data on the thin client is transmitted to the client PC, and frame data of the screen image to be output is transmitted to the thin client from the client PC.

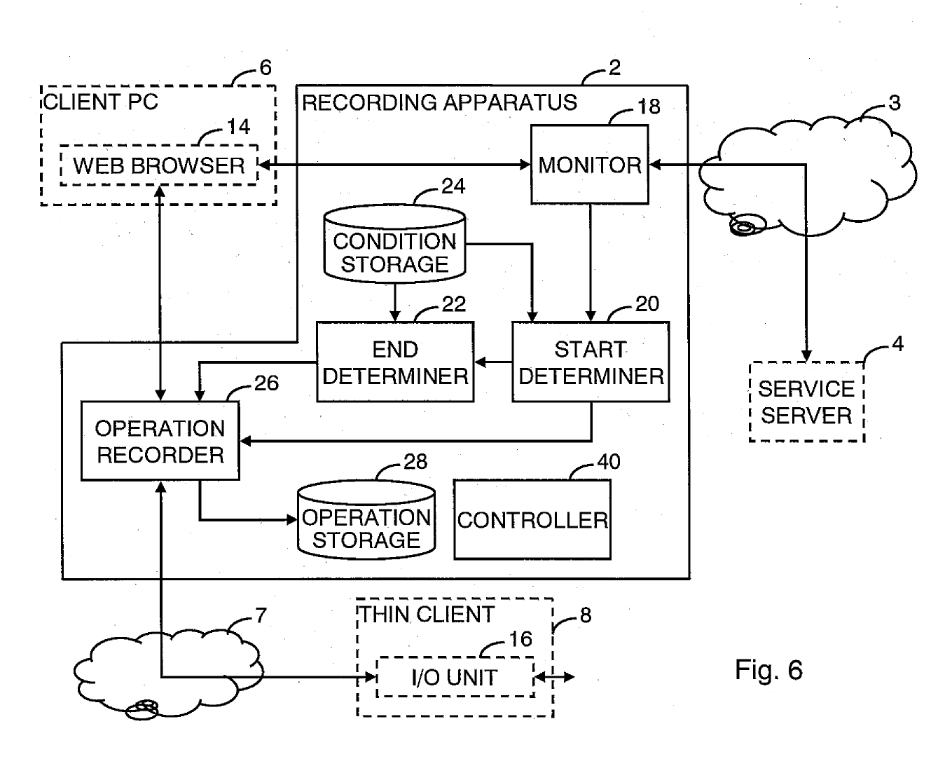

FIG. 6 is a diagram illustrating a system configuration of a recording apparatus according to a second embodiment of the present invention. For the purpose of a simple description, the communicator in each apparatus is omitted in FIG. 6. Similarly, the prior notice issuer 30 and the notice issuer 32 in the recording apparatus are omitted for the purpose of a simple description. A monitor 18, a start determiner 20, an end determiner 22, a condition storage 24, an operation recorder 26, and an operation storage 28 shown in FIG. 6 are similar to those shown in FIG. 1. A realizing approach of the recording apparatus 2 is arbitrary. However, according to the second embodiment of the present invention, the recording apparatus 2 is constructed on a proxy server. The controller 40 executes all functions, that are not explicitly discussed in the specification, of the recording apparatus 2, including functions of a general proxy server.

A flow of process for instructing the start/end of the recording process in the recording apparatus 2 according to the second embodiment of the present invention is basically the same as the flowchart shown in FIG. 3. However, the Web browser 14 is on the client PC 6 and the monitor 18 therefore monitors a communication message for Web access, sent to the service server 4 from the client PC 6 in Operation S102.

Since the I/O unit 16 is on a thin client 8, the operation recorder 26 acquires and records communication data sent or received between the thin client 8 and the client PC 6 through a communication work 7. The screen data to be recorded is not captured data of a display image within a display window of the Web browser, but frame data on the entire display screen. Therefore, a flow of the recording process of data indicative of user operations in the recording apparatus according to the second embodiment of the present invention is slightly different from the flowchart shown in FIG. 4.

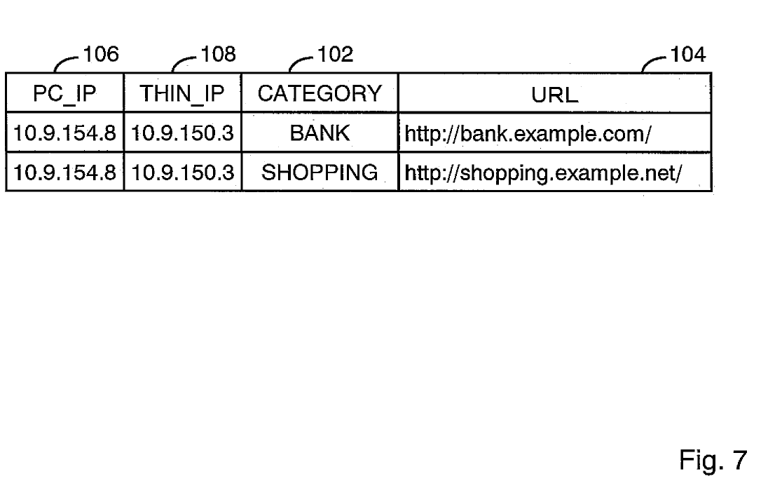

FIG. 7 is a diagram illustrating an example of a URL list stored in a condition storage in a recording apparatus according to a second embodiment of the present invention. The condition storage 24 stores an IP (Internet Protocol) address of a client PC which is the target of recording data indicative of user operations, an IP address of a thin client operated by the user so as to operate the client PC, and a URL of the access destination. As shown in FIG. 7, a record of a URL list stored in the condition storage 24 includes a “PC_IP” section 106, a “Thin_IP” section 108, a “category” section 102, and a “URL” section 104. The “PC_IP” section 106 stores an IP address of the client PC, and the “Thin_IP” section 108 stores an IP address of the thin client. The URL of the access destination may be registered to every client PC or, alternatively, may be treated as common data to all client PCs.

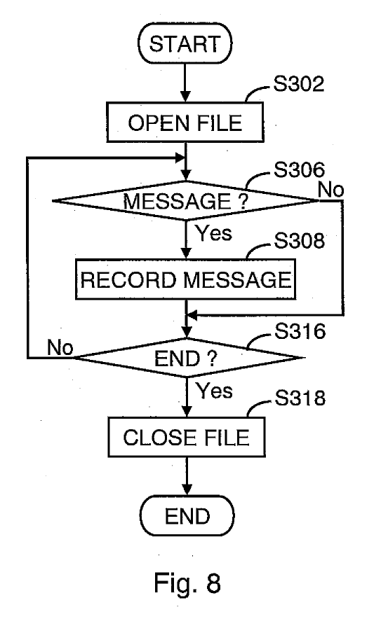

FIG. 8 is a diagram illustrating a flowchart of a recording process of data indicative of user operations in a recording apparatus according to a second embodiment of the present invention. A flow of the recording process of data indicative of user operations according to the second embodiment of the present invention will be discussed with reference to FIG. 8.

(Operation S302) The operation recorder 26 creates and opens a file for storing the operation data, and writes the IP address of the client PC as the access source and the URL of the access destination to the file for storing the operation data.

(Operation S306) The operation recorder 26 checks whether there is a communication message to be sent or received between the IP address of the client PC as the access source and the IP address of the thin client thereof. If there is not such a communication message (No in Operation S306), the process advances to Operation S316.

(Operation S308) If there is such a communication message (Yes in Operation S306), the operation recorder 26 records the communication message.

(Operation S316) The operation recorder 26 checks whether the end determiner 22 has instructed to end the recording process. If the end determiner 22 has not instructed to end the recording process (No in Operation S316), the process advances to Operation S306.

(Operation S318) If the end determiner 22 has instructed to end the recording process (Yes in Operation S316), the operation recorder 26 closes the file for storing the operation data and stores the closed file to the operation storage 28.

According to the second embodiment of the present invention, since the monitoring process and recording process are performed out of the client PC, the recording apparatus does not depend on software for operating the client PC, and the influence from virus invading on the client PC can be removed.

In the second embodiment of the present invention, the operation recorder 26 may be realized as a device separated from the recording apparatus 2. In this case, the operation recorder 26 communicates with the recording apparatus 2, and performs the recording process in response to an instruction from the recording apparatus 2. The operation storage 28 may be attached to the operation recorder 26 or may be alternatively attached to another device, separately from the operation recorder 26. If the operation storage 28 is separated from the operation recorder 26, the operation recorder 26 transmits the data indicative of user operations to the recording apparatus 2 or another device through a communication network.

The apparatus according to the embodiments of the present invention can be embodied as hardware or software of a computer. For example, by creating a program for enabling the computer to execute functions of the communicator 12, Web browser 14, monitor 18, start determiner 20, end determiner 22, operation recorder 26, prior notice issuer 30, notice issuer 32, and controller 40 and by reading the program to a memory of the computer and executing the program, the recording apparatus can be realized.

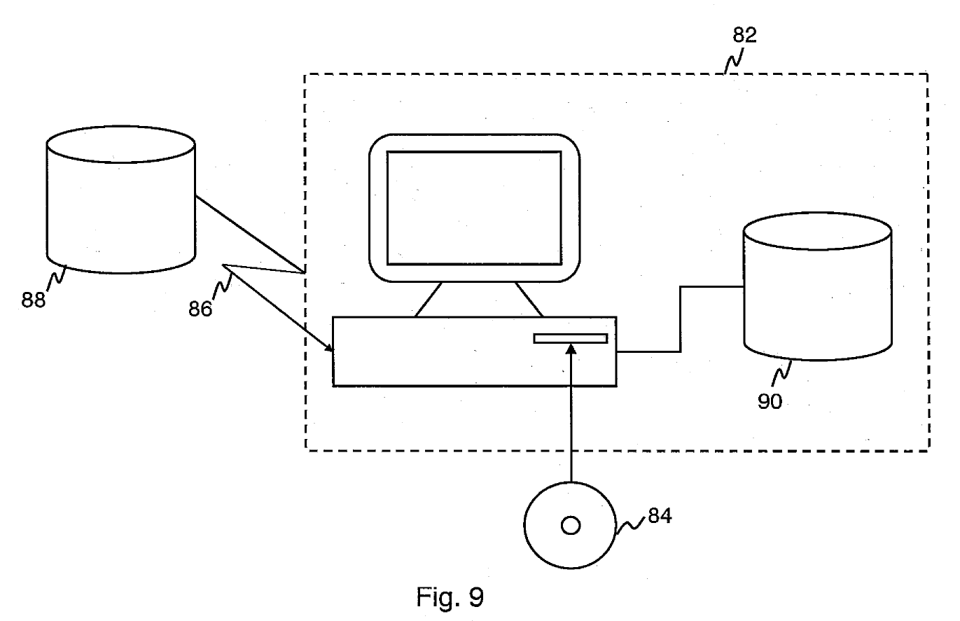

As shown in FIG. 9, the program for realizing the recording apparatus according to the embodiments of the present invention may be recorded not only to a movable recording medium 84 such as a CD-ROM, CD-RW, DVD-RAM, DVD-RW, or a flexible disk, but also to another storing device 88 provided at the other end of a communication line 86 or a storing device or recording medium 90 such as a hard disk or RAM of a computer system 82. Upon executing the program, the program is loaded and executed on a main memory.

The components in the recording apparatus according to the embodiments of the present invention may be realized by arbitrary combination thereof. A plurality of components may be realized as one member, or one component may include a plurality of members.

What is claimed is:

1. A recording apparatus for recording data indicative of user operations, comprising:
a monitor for monitoring a sending process or receiving process of a communication message to acquire said message;
a start determiner for determining, by analyzing acquired communication message, whether to start a recording process of data indicative of user operations executed after sending or receiving the acquired communication message; and
an operation recorder for starting the recording process in accordance with a determination result in the start determiner.

2. The recording apparatus of claim 1, wherein
said start determiner includes at least one of
a first determiner for
determining to start the recording process when the acquired communication message complies with a cipher communication protocol, and
outputting a determination result indicating an instruction of starting the recording process,
a second determiner for
determining to start the recording process when a source of an acquired receiving communication message or a destination of an acquired sending communication message is a predetermined server, and
outputting a determination result indicating an instruction of starting the recording process, and
a third determiner for
determining to start the recording process on the basis of a content of the acquired communication message, and
outputting a determination result indicating an instruction of starting the recording process.

3. The recording apparatus of claim 1, wherein
said operation recorder includes at least one of
a first recorder for recording, as the data indicative of user operations, screen data for a screen image displayed during the user operations, and
a second recorder for recording, as the data indicative of user operations, data input during the user operations.

4. The recording apparatus of claim 1, wherein
said operation recorder sends, as the recording process, the data indicative of user operations to an apparatus connected through a communication network.

5. The recording apparatus of claim 1, wherein
said start determiner identifies, on the basis of the acquired communication message, a session management process of the sending process or receiving process of the acquired communication message and determines whether to start the recording process for each of identified session management processes, and
said operation recorder records data indicative of user operations accepted by a window management process corresponding to each of the identified session management processes.

6. The recording apparatus of claim 1, further comprising
a notice issuer for issuing, during the recording process, a notice to the effect that a recording process is going.

7. The recording apparatus of claim 1, further comprising
a prior notice issuer for issuing, upon outputting a determination result indicating an instruction of starting the recording process, a prior notice to the effect that a recording process is about to start,
wherein
said operation recorder starts the recording process of data indicative of user operations after the prior notice has been issued.

8. The recording apparatus of claim 1, wherein
said operation recorder records, along with the data indicative of user operations, data of a source of an acquired receiving communication message or a destination of an acquired sending communication message.

9. The recording apparatus of claim 1, further comprising at least one of
a first end determiner for
determining to end the recording process after a predetermined time from a start of the recording process, and
instructing end of the recording process;
a second end determiner for
determining to end the recording process upon detecting an access to a server different from a server as a source of an acquired receiving communication message or a destination of an acquired sending communication message, and
instructing end of the recording process;
a third end determiner for
determining to end the recording process upon detecting a closing of a window managed by a window management process corresponding to a session management process of a sending process or receiving process of the acquired communication message on the basis thereof the recording process has been determined to start, and
instructing end of the recording process; and
a fourth end determiner for
determining to end the recording process after a predetermined time of absence of user operations after a start of the recording process, and
instructing end of the recording process.

10. A computer readable storage medium storing a program of instructions to a computer for acting as a recording apparatus for recording data indicative of user operations, said recording apparatus comprising:
a monitor for monitoring a sending process or receiving process of a communication message to acquire said message;
a start determiner for determining, by analyzing acquired communication message, whether to start a recording process of data indicative of user operations executed after sending or receiving the acquired communication message; and
an operation recorder for starting the recording process in accordance with a determination result in the start determiner.

11. A method executed by a computer for recording data indicative of user operations, comprising:
acquiring a sending or receiving communication message;
analyzing acquired communication message to determine on the basis of an analysis result whether to start a recording process of data indicative of user operations executed after sending or receiving the acquired communication message; and
starting the recording process in accordance with a determination result in the operation of analyzing acquired communication message.
